(19) United States
(12) Patent Application Publication
(10) Pub. No.: US 2003/0053465 A1
(43) Pub. Date: Mar. 20, 2003

(54) System and method for traffic interface scalability in a network packet core function

(76) Inventors: Sanjeevan Sivalingham, San Diego, CA (US); Ravi Palakodety, San Diego, CA (US)

Correspondence Address: COATS & BENNETT, PLLC, P O BOX 5, RALEIGH, NC, 27602, US

(21) Appl. No.: 09/957,101

(22) Filed: Sep. 20, 2001

(51) Int. Cl. H04L 12/28

(52) U.S. Cl. 370/401; 370/352

(57) ABSTRACT

A packet control function (PCF) in a wireless communication network comprises a scalable architecture allowing independently addressable packet data serving node (PDSN) interfaces to be added as needed or desired. Each interface functions as an independent IP interface supporting data connections between one or more base station controllers (BSCs) supported by the PCF and the PDSN. With this implementation, a single PCF appears to the PDSN as one or more “pseudo PCFs” depending upon the number of IP interfaces implemented in the PCF. Each IP interface supports a given data throughput capacity so that the aggregate data throughput capacity of the PCF may be scaled as a function of the number of IP interfaces implemented within it. Load sharing and fault handling techniques implemented by the PCF further exploit the advantages gained from having multiple IP interfaces with the PDSN.

### BACKGROUND OF THE INVENTION

The present invention generally relates to wireless communication packet data networks, and particularly relates to scalability provisions for selected traffic interfaces in the network packet core function.

Wireless communication network architectures necessarily evolve with the changing types of wireless communication services demanded by subscribers. One pervasive force, the Internet with all its diverse content, has brought packet data into the core of the wireless access network. Indeed, evolving access network architectures are moving towards essentially all-IP (Internet protocol) routing between the various network entities that collectively provide access terminals with connections to the Internet. High data rate (HDR) networks implemented in accordance with the TIA/EIA/IS-856 standard are one example of data-only wireless access networks that support high-rate connections between access terminals and the Internet, or other packet data networks (PDNs).

In a generalized network architecture that might be employed in an '856 network or other high data rate network, access terminals communicate via RF signaling with radio base stations (RBSs), which are in turn controlled by one or more base station controllers (BSCs). Each BSC communicates with a packet core function, also referred to as a packet control function (PCF), which serves as a specialized router that manages traffic going between the various BSCs and a gateway device, such as a high capacity router, connected to the Internet or other PDN. The gateway device, referred to as a packet data serving node (PDSN) and the PCF incorporate a variety of features and processes that allow them to validate, route, and synchronize the IP traffic flowing through the network.

Communication between the PCF and the PDSN is IP-based in the TIA/EIA/IS2000 standard, for example, and the same is true for HDR networks. Thus, traffic between the BSCs and the PDN is routed through an IP stack in the PCF and passes over the A10/A11 interfaces between the PCF and PDSNs. From the perspective of the PDSN each PCF conventionally presents a single IP address to the associated PDSN, and all traffic to and from the PCF is routed through that one IP address. Hence, with the conventional approach, the PCF routes all traffic through a single IP stack. From the perspective of the mobile stations or BSCs, each PCF may be identified by its Packet Zone ID. More specifically, the BSCs transmit a Packet Zone ID over the air interface to the access terminals that in turn may use the Packet Zone ID to identify the coverage area of the serving PCF. When an access terminal receives a new Packet Zone ID that is different from the previously received Packet Zone ID, the access terminal recognizes that it has moved into a new coverage area served by a new PCF.

With increasing data rates, and the need to support more subscribers per BSC, the volume and rate of traffic carried by the PCF is substantial. Increasing IP traffic throughput of the PCF becomes challenging because scaling the performance of a single IP stack necessarily entails increasing its raw processing performance. That is, with a single IP stack, one must increase the throughput in Megabits/second (Mbps) of the overall protocol stack to increase the traffic handling capacity of the PCF. This may be expensive in terms of driving processing speeds upwards, and faces the further disadvantage of not addressing fault tolerance concerns. With a single IP interface to the PDSN, failure of that interface may have significant loss-of-service consequences.

Ideally, a PCF would incorporate an interface to the PDSN that offers a practical mechanism or approach to scaling its performance. Any such approach to scalability should complement the competing desires of system operators to balance equipment costs against desired performance, and should lend itself to easy configurability. Further, the ideal implementation would address the single-point of failure concerns attendant with conventional PCF-to-PDSN interfaces.

### SUMMARY OF THE INVENTION

The present invention comprises methods and apparatus for implementing essentially any number of so-called “pseudo” or “virtual” packet control functions (PCFs) within the framework of the standard PCF-to-PDSN interfaces. A PCF adapted in accordance with the present invention comprises one or more pseudo PCFs. Each pseudo PCF offers a separately addressed IP interface to the associated PDSN, but the composite PCF offers a consolidated interface on the BSC side. The composite PCF is adapted to route traffic between one or more BSCs and a PDSN using any one of a plurality of IP interfaces. From the perspective of the PDSN, each composite PCF appears to be a number of independent or pseudo PCFs individually having an IP interface. From the perspective of the BSCs or access terminals, each composite PCF appears to be a single entity with a single interface because each composite PCF only has a single Packet Zone ID.

With the present invention, PCF traffic throughput may be improved by simply increasing the number of IP interfaces (e.g., IP stacks) implemented within the PCF. Scalability may be implemented, for example, by simply adding standardized IP interface cards or other hardware or software extensions to the present inventive PCF. Thus, system operators may scale the capacity of a given PCF through simple configuration choices that determine the number of pseudo PCF interfaces supported by the PCF's hardware and software. This scaling approach avoids tying ultimate PCF throughput to raw processing speed, which approach can escalate costs quickly and still fall short of performance goals.

Each pseudo PCF comprises a separate protocol stack that includes the IP layer as well as the link/physical layers, such as an Asynchronous Transfer Mode (ATM) and an Optical Carrier (OC-3). Alternatively, the pseudo PCFs within the PCF may share selected hardware and software resources. Decisions as to how many and what resources are shared between pseudo PCFs reflect varying priorities for, among other things, balancing economies of scale, performance capabilities, architectural complexity, and fault tolerance.

### BRIEF DESCRIPTION OF THE DRAWINGS

FIG. 1 is a diagram of an exemplary wireless communication network that includes a PCF adapted in accordance with the present invention.

FIG. 2 is a more detailed diagram of an exemplary embodiment for the PCF of FIG. 1.

FIG. 3 is a diagram of exemplary PCF and PDSN protocol stacks.

FIG. 4 is a diagram of a modular hardware approach to implementing the PCF of FIG. 2.

FIG. 5 is a diagram of an integrated BSC-PCF.

### DETAILED DESCRIPTION OF THE INVENTION

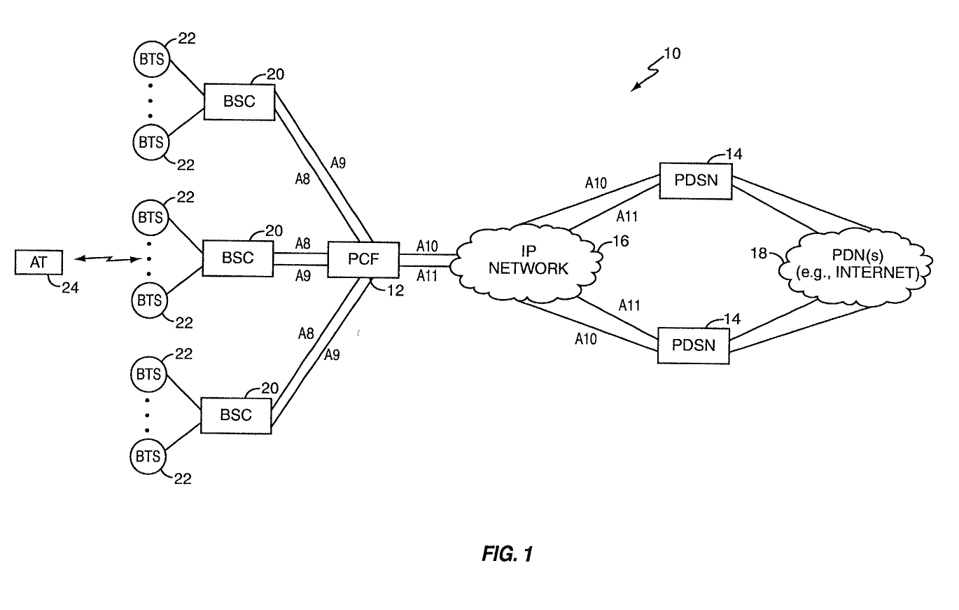

FIG. 1 is a diagram of an exemplary communication network 10, including a packet control function (PCF) 12 adapted in accordance with the present invention. In addition to the PCF 12, the network 10 further comprises one or more packet data serving nodes (PDSN) 14 coupled to the PCF 12 through an IP network 16. The PDSNs 14 are coupled to one or more packet data networks (PDNs) 18, which might be, for example, the Internet. The network 10 additionally comprises one or more base station controllers (BSCs) 20, and a plurality of base station transceiver systems (BTSs) 22.

In operation, the network 10 provides data connections between one or more access terminals (ATs) 24 and the PDN 18. Packet data associated with a data connection for a given AT 24 is routed by the PCF 12 to and from the BSC 20 supporting that connection. Thus, packet data from the PDN 18 is routed by the appropriate PDSN 14 to the PCF 12, and from there the PCF 12 delivers it to the appropriate BSC 20, which in turn provides the data to the appropriate BTS 22 or BTSs 22 supporting wireless communication with the AT 24. In reverse, data from an AT 24 travels via RF signaling to one or more of the BTSs 22, which send it on to the supporting BSC 20. The BSC 20 formats the data appropriately and passes it along to the supporting PCF 12, which in turn routes it through IP network 16 to one of the PDSNs 14, where it is passed along to the PDN 18.

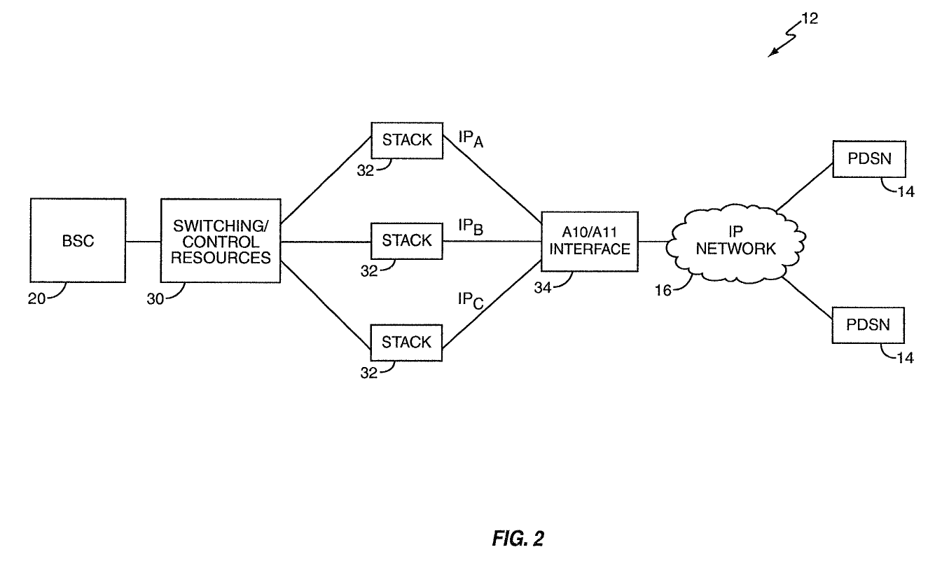

FIG. 2 is a simplified illustration of a portion of the network 10, and provides additional details of the PCF 12. Conventionally, a PCF is identified to the PDSN 14 using a single IP interface, associated by the PDSN with a single IP address. Thus, all data routed between the PCF 12 and the PDSN 14 would conventionally flow through this single IP interface. In contrast, the PCF 12 of the present invention includes a number of “pseudo PCFs” 32, which function as separately addressable IP interfaces relative to the PDSN 14. The PCF 12 further comprises switching and control resources 30 that provide a unified or composite interface for the pseudo PCFs 32 relative to the BSC 20, and the A10/A11 interface 34 for communicating with one or more PDSNs 14. For complete details of the A10/A11 interface, one may refer to the International Organization for Standards document for interoperability standards, IOS v4.0.

In operation, PCF 12 appears to the PDSN 14 to be a number of conventional PCFs, which number is determined by the number of pseudo PCFs 32 implemented within PCF 12. Each pseudo PCF 32 provides a separate IP interface to the PDSN 14, illustrated as IP_{A}, IP_{B}, and IP_{C}, corresponding to the three pseudo PCFs 32 shown. Of course, the depicted configuration is exemplary only, and the PCF 12 may have a greater or lesser number of pseudo PCFs 32. In any case, the switching and control resources 30 provide a BSC interface that insulates the BSC 20 from the details associated with the pseudo-PCF implementation of PCF 12.

By insulating the BSCs 20 from pseudo-PCF implementation details, each BSC 20 supported by the PCF 12 appears to have a single, standards-compliant interface with the PCF 12. BSCs 20 are not required to know which pseudo PCF 32 is handling their respective traffic (data connections). Indeed, from an operational perspective, the BSCs 20 supported by the PCF 12 need not recognize it as anything other than a conventional PCF.

One advantage of implementing PCF 12 as a composite of pseudo PCFs 32 is that the aggregate data throughput capability of the PCF 12 may be scaled or adjusted as a function of the number of pseudo PCFs 32 implemented within the PCF 12. As will be detailed later, the physical implementation of PCF 12 may be such that a system operator simply adds or subtracts pseudo PCFs based on data throughput requirements. This technique is a better approach than simply trying to improve the performance of a single IP interface, because the performance requirements imposed on an individual pseudo PCF 32 may be held within reasonable limits, while still allowing for a high aggregate data throughput capability of the PCF 12.

Each pseudo PCF 32 implements at least a portion of the protocol stack required to support communication with the PDSN 14, where each protocol stack implemented within a pseudo PCF 32 functions as a separately addressable IP interface with the PDSN 14. With this configuration, the switching/control resources 30 of PCF 12 can route data from the BSCs 20 to the PDSN 14 and vice versa through the A10/A11 interface 34 and any one of the separate IP interfaces of the pseudo PCFs 32. From the perspective of the PCF 12, the pseudo PCFs 32 and A10/A11 interface 34 may be considered in at least some embodiments as collectively comprising the PDSN interface.

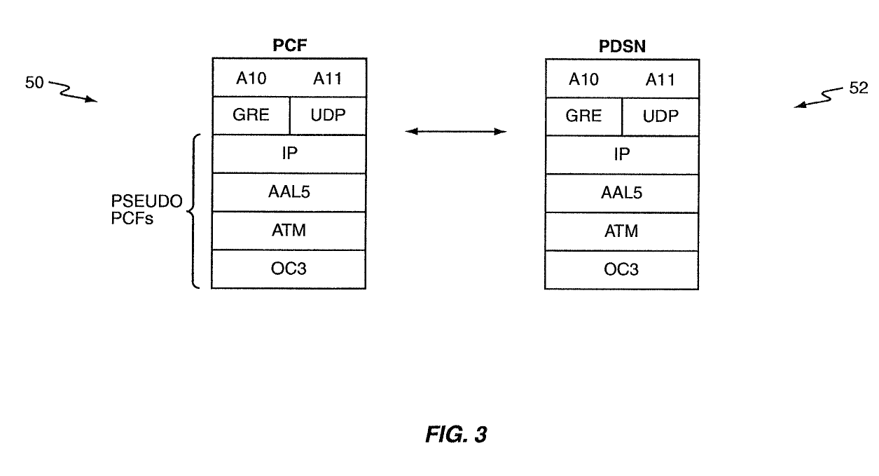

FIG. 3 illustrates exemplary protocol stacks as might be implemented in each of the pseudo PCFs 32. It should be noted that the details of the PCF protocol stack 50 and corresponding PDSN protocol stack 52 may differ significantly depending upon implementation details in network 10, and particularly with regard to the lower level protocols toward the bottom of the stacks 50 and 52 (below the IP layer). Indeed, these lower level protocols are almost entirely implementation dependent. Here, the PCF 12 communicates with the PDSN 14 through an OC3 connection, on which IP-over-ATM traffic is carried. These specific implementation details account for the configuration of the lowest layers of the protocol stacks 50 and 52, and specifically incorporate the OC3, ATM, and ATM Adaptation Layer 5 (AAL5) protocol layers.

Generally, the pseudo PCFs 32 individually incorporate an independent protocol stack at least up to the IP layer, so that each pseudo PCF 32 acts as a separately addressable IP interface with the PDSN 14. Above the IP layer, pseudo PCFs 32 may share portions of the protocol stack 50. For example, the Generic or General Routing Encapsulation (GRE) and User Datagram Protocol (UDP) layers used by the A10 and A11 interfaces may be implemented in whole or in part by the pseudo PCFs 32 installed within the PCF 12.

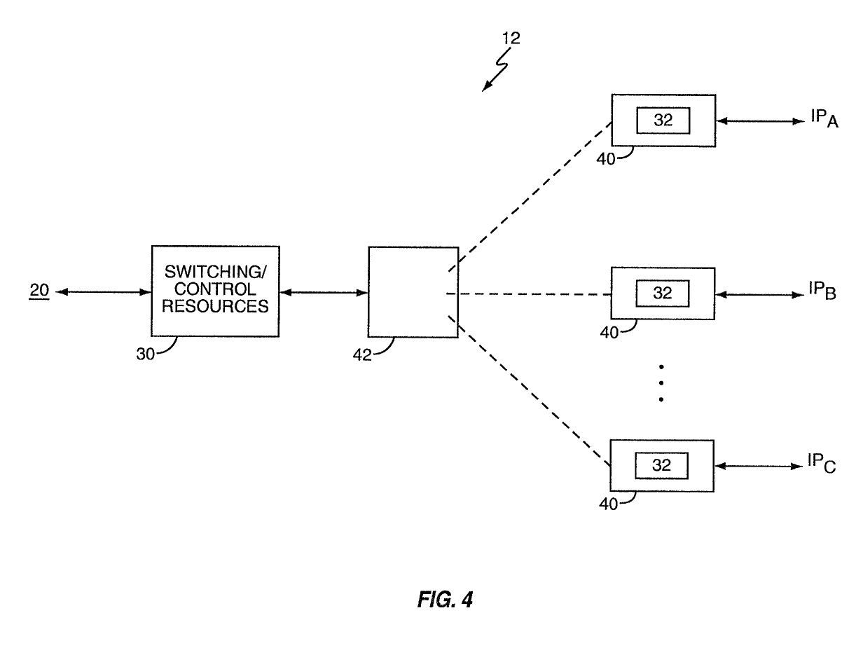

FIG. 4 is a diagram of the PCF 12 that illustrates in more detail an exemplary hardware arrangement for its implementation. Again, the PCF 12 comprises the switching and control resources 30, which control the routing of data through the separately addressable IP interfaces (pseudo PCFs 32). In the embodiment illustrated by FIG. 4, the pseudo PCFs 32 are preferably implemented on a per-card basis. Thus, adding a pseudo PCF 32 to the PCF 12 entails simply adding an interface card 40 to a main board 42. In some instances, the main board 42 may comprise a rack or sub-rack system. With this configuration, the board 42 and the cards 40 comprise one embodiment of a scalable PDSN interface having an aggregate data throughput capability determined by the number of interface cards 40 installed. The A10/A11 interface 34 may be implemented in a number of locations, including the cards 40, the board 42, or some combination thereof. This scalable configuration represents one technique for implementing a modular PDSN interface. These scalability concepts may be applied to alternative configurations not adopting the board/card approach.

A number of advantages flow from the pseudo PCFs implementation of the PCF 12. For example, a controller included in the switching and control resources 30 may implement any number of techniques or procedures for utilizing the pseudo PCFs 32. In a PCF configuration where multiple pseudo PCFs 32 are installed, the controller may implement load sharing where it dynamically distributes or assigns the data connections being supported by the PCF 12 amongst the available pseudo PCFs 32. This type of load sharing function allows the PCF 12 to efficiently utilize the aggregate IP interface resources represented by the collection of pseudo PCFs 32.

In at least some embodiments, the controller evenly distributes the overall traffic load amongst the available pseudo PCFs 32. More specifically, the controller may dynamically or selectively assign data connections to the available pseudo PCFs so that the overall load would be evenly distributed amongst the available pseudo PCFs 32. To do so, the controller may be configured to predict a future amount of traffic that would be routed through each pseudo PCF 32. Such prediction may be accomplished by configuring the controller to recognize, for example, the number of data connections associated with each pseudo PCF 32 and consider past traffic that was previously routed through each data connection.

Fault tolerance is another added benefit of implementing the PCF 12 with multiple pseudo PCFs 32. As earlier noted, each pseudo PCF 32 appears to be a conventional PCF (i.e., a PCF having only a single IP interface) to the PDSN 14. If a given pseudo PCF 32 fails, the data connections supported by that failed pseudo PCF 32 may be handed off to an operationally available pseudo PCF 32. In at least some embodiments, the data connections supported by the failed pseudo PCF 32 may be dynamically handed off to another one of the operationally available pseudo PCFs 32 installed in the PCF 12, and such handoff operations would appear to the PDSN 14 as conforming to a standard handoff of a data connection between two conventional PCFs.

Load management functions may also support dormancy operations. For example, one or more controllers in the switching and control resources 30 may implement load-sharing functions between the pseudo PCFs 32 in handling reactivation of a dormant AT 24. A given AT 24 may establish a data connection through network 10 and then subsequently become idle. The network 10 may release the over-the-air traffic channel resources associated with the AT 24 during such idle periods to insure efficient use of the limited RF spectrum.

When the connection for the AT 24 was initially established, the connection was assigned to a given one of the available pseudo PCFs 32. Upon re-activation of the connection, the controller may assign the connection to the same pseudo PCF 32, or may, in the interest of load balancing or other considerations, assign the reactivated connection to a different pseudo PCF 32. Such reassignment procedures between pseudo PCFs 32 appear to the PDSN(s) 14 to be a standard connection handoff between conventional PCFs. In any case, this management of resources is transparent to the IP applications running at either end of the connection (i.e., the ATs 24 and PDSNs 14).

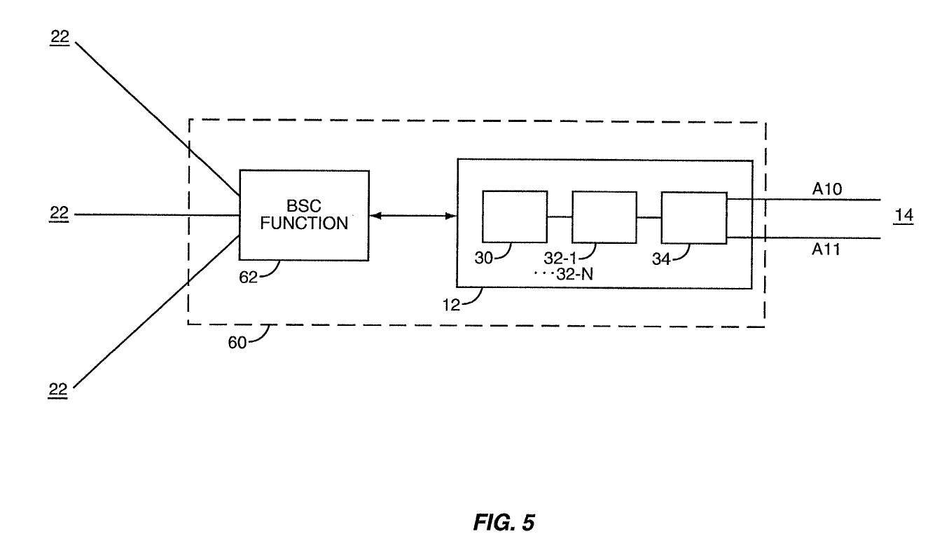

In some implementations of the network 10, it may be desirable to integrate the features of the BSC 20 with the PCF 12. FIG. 5 illustrates an integrated BSC-PCF 60 that preferably uses a conventional BSC architecture to integrate a BSC function 62 having capabilities similar to the BSC 20 illustrated in FIG. 1 with a PCF 12. It should be noted that the interface between the BSC function 62 and the PCF 12 in this integrated architecture may still be implemented in accordance with the A8/A9 standardized interfaces used to couple stand-alone BSCs with PCFs. As before the PCF 12 provides a number of separately addressable IP interfaces in the form of pseudo PCFs, denoted here as pseudo PCFs 32-1 through 32-N, for communicating with the PDSN 14.

Those skilled in the art will recognize that the pseudo PCF concepts discussed above lend themselves to significant variation. For example, PDSN interface modularity may be based on varying combinations of independent and dependent (shared) hardware and software. Thus, the above exemplary details should not be construed as limiting the present invention; rather the present invention is limited only by the following claims and the reasonable equivalents thereof.

What is claimed is:

1. A packet control function (PCF) to route data between one or more base station controllers (BSCs) and a packet data serving node (PDSN) in a communication network, said packet control function comprising:
two or more separately addressed Internet Protocol (IP) interfaces for communicating with the PDSN;
a BSC interface for communicating with the one or more BSCs; and
switching and control resources to direct the data through at least one of said two or more IP interfaces as desired.

2. The PCF of claim 1 wherein said switching and control resources comprise a controller to apportion the data between said two or more IP interfaces.

3. The PCF of claim 1 wherein the data being routed between the one or more BSCs and the PDSN is associated with one or more data connections, and further wherein the switching and control resources further comprises a controller to selectively assign data connections to said two or more IP interfaces.

4. The PCF of claim 3 wherein said controller implements load sharing in assigning the data connections to said two or more IP interfaces.

5. The PCF of claim 3 wherein said controller implements fault-based reassignment of data connections associated with a failed one of said two or more IP interfaces.

6. A packet control function (PCF) for use in routing data between a base station controller (BSC) and a packet data serving node (PDSN) in a communication network, said PCF comprising:
a scalable PDSN interface for communicating with the PDSN, said scalable PDSN interface comprising one or more separately addressable Internet Protocol (IP) interfaces, said PCF being configured with a desired number of said separately addressable IP interfaces to the PDSN;
a BSC interface for communicating with the BSC; and
switching and control resources to control data routing operations of said PCF.

7. The PCF of claim 6, wherein said scalable PDSN interface comprises a modular PDSN interface having a card-based system to support separately addressable IP interfaces, and further wherein said PCF is configured with a desired number of said separately addressable IP interfaces to the PDSN based on a card configuration of said modular PDSN interface.

8. The PCF of claim 7 wherein a data throughput of said PCF may be selected as desired based on selecting the card configuration of said modular PDSN interface.

9. The PCF of claim 7 wherein at least a portion of each said separately addressable IP interface provided by said modular PDSN interface comprises an IP interface card.

10. The PCF of claim 9 wherein each said IP interface card implements at least a portion of a protocol stack supporting communication with the PDSN independently from other said IP interface cards.

11. The PCF of claim 10 wherein each said IP interface card independently implements the protocol stack supporting communication with the PDSN.

12. The PCF of claim 9 wherein said IP interface cards share selected layers of the protocol stacks supporting communication with said PDSN.

13. The PCF of claim 6 wherein said switching and control resources implement load balancing between said separately addressable IP interfaces for the data being routed by said PCF.

14. The PCF of claim 6 wherein the data being routed by said PCF is associated with one or more data connections, and further wherein said switching and control resources transfer data connections from a failed IP interface to at least one working IP interface such that the transfers appear to the PDSN as standard connection handoffs between PCFs.

15. The PCF of claim 6 wherein a data throughput of the BSC with respect to said PDSN may be scaled as desired by changing the desired number of said separately addressable IP interfaces.

16. A BSC integrating the PCF of claim 6.

17. A method of providing data throughput scalability in a packet control function (PCF) routing data between a base station controller (BSC) and a packet data serving node (PDSN) in a communication network, the method comprising:
implementing said PCF with a scalable PDSN interface comprising one or more separately addressable IP interfaces to said PDSN, wherein each of said separately addressable IP interfaces has a given data throughput capability; and
adjusting the number of said separately addressable IP interfaces installed in said PCF to set an aggregate data throughput capability of said PCF.

18. The method of claim 17 wherein each said separately addressable IP interface to said PDSN functions as a “pseudo PCF” such that said PCF appears to said PDSN as a number of single IP-interface PCFs equal to the number of said pseudo PCFs installed in said PCF.

19. The method of claim 17 further distributing the data being routed by said PCF among said one or more separately addressable IP interfaces for routing.

20. The method of claim 17 further comprising distributing data being routed via one of said IP interfaces that has operationally failed to at least one other said IP interface that is operationally available, so that said data will be routed via the at least one other said operationally available IP interface.

21. The method of claim 17 further comprising physically integrating the BSC and the PCF, wherein an aggregate data throughput capability of said BSC relative to said PDSN is a function of the number of said separately addressable IP interfaces implemented in said PCF.

22. The method of claim 17 wherein implementing said PCF with a scalable PDSN interface comprising one or more separately addressable IP interfaces to said PDSN comprises configuring said PCF with a modular PDSN interface adapted to include one or more interface modules, each said module providing at least one of said separately addressable IP interfaces.

23. The method of claim 17 further comprising implementing a load sharing function for managing reactivation of previously dormant data connections associated with idle access terminals, said load sharing function bearing on assignment of the reactivated data connections to particular ones of said separately addressable IP interfaces.

24. The method of claim 23 wherein implementing a load sharing function for managing reactivation of previously dormant data connections associated with idle access terminals comprises assigning a reactivated data connection that was previously assigned to a first one of said separately addressable IP interfaces to a second one of said separately addressable IP interfaces to balance data connection loading between at least said first and second ones of said separately addressable IP interfaces.

25. A packet control function (PCF) for use in routing packet data between one or more base station controllers (BSCs) and a packet data serving node (PDSN) in a wireless communication network, said PCF comprising:
a scalable PDSN interface comprising one or more separately addressable IP interfaces for communicating with said PDSN;
a BSC interface for communicating with said BSC;
switching resources for selectively routing said packet data through the separately addressable IP interfaces; and
a controller for managing said switching resources.

26. The PCF of claim 25 wherein said scalable PDSN interface comprises a main board and one or more interface cards, wherein each of said one or more interface cards comprises at least one of the separately addressable IP interfaces to said PDSN.

27. The PCF of claim 25 wherein said switching resources comprise A10/A11 switching resources.

28. The PCF of claim 25 wherein said controller is operative to implement load sharing between said separately addressable IP interfaces.

29. The PCF of claim 25 wherein said controller is operative to handoff data connections associated with said packet data from a first one of said separately addressable IP interfaces to a second one of said separately addressable IP interfaces if said first one fails.

30. The PCF of claim 25 wherein said controller is operative to reassign a data connection previously assigned to a first one of said separately addressable IP interfaces to a second one of said separately addressable IP interfaces, wherein said data connection is associated with a previously dormant access terminal.
